(19) United States
(12) Patent Application Publication
(10) Pub. No.: US 2023/0126354 A1
(43) Pub. Date: Apr. 27, 2023

(54) DEVICE AND METHOD FOR CONTROLLING REGENERATIVE BRAKING OF ELECTRIFIED VEHICLE

(71) Applicants: HYUNDAI MOTOR COMPANY, Seoul (KR); Kia Corporation, Seoul (KR)

(72) Inventor: Jung Wan KIM, Yongin-si (KR)

(73) Assignees: HYUNDAI MOTOR COMPANY, Seoul (KR); Kia Corporation, Seoul (KR)

(21) Appl. No.: 17/703,272

(22) Filed: Mar. 24, 2022

(30) Foreign Application Priority Data
Oct. 22, 2021 (KR) 10-2021-0141938

(51) Int. Cl. B60L 7/18

(52) U.S. Cl. CPC B60L 7/18; B60L 2250/28; B60L 2240/26; B60L 2240/12; B60L 2240/461; B60L 2240/465; B60L 2240/16

(57) ABSTRACT

A device and a method for controlling regenerative braking of an electrified vehicle includes a drive motor configured for generating power required to drive wheels, and a controller electrically connected to the drive motor, and the controller detects vehicle data when braking the vehicle, determines whether a wheel slip of the vehicle has occurred based on the vehicle data, determines a first regenerative braking amount based on a deceleration and a vehicle model when the wheel slip has not occurred, determines a second regenerative braking amount based on a maximum road surface utilization rate when the wheel slip has occurred, and controls maximum regenerative braking of the drive motor based on the first regenerative braking amount or the second regenerative braking amount.

### CROSS-REFERENCE TO RELATED APPLICATION

The present application claims priority to Korean Patent Application No. 10-2021-0141938, filed on Oct. 22, 2021, the entire contents of which is incorporated herein for all purposes by this reference.

### BACKGROUND OF THE PRESENT DISCLOSURE

### Field of the Present Disclosure

The present disclosure relates to a device and a method for controlling regenerative braking of an electrified vehicle.

### Description of Related Art

With a recent high-performance electric vehicle development trend, many vehicles in which a front axle and a rear axle are independently driven using dual motors have been developed. Such vehicles exhibit a high performance compared to an existing long-range specification in which only one axle is driven, but have a relatively short maximum mileage. In other words, an electrified vehicle provided with the dual motors has a lower electric economy (a mileage for each kWh) than an electrified vehicle provided with a single motor. Accordingly, studies for improving the electric economy by increasing a regenerative braking force of the electrified vehicle provided with the dual motors are being conducted. In a field of commercial vehicles such as autonomous buses and trucks, an increase in the regenerative braking force becomes an important competitive point for an economic efficiency. Therefore, such studies focus on improving the electric economy by maximizing the regenerative braking force.

The information included in this Background of the present disclosure section is only for enhancement of understanding of the general background of the present disclosure and may not be taken as an acknowledgement or any form of suggestion that this information forms the related art already known to a person skilled in the art.

### BRIEF SUMMARY

Various aspects of the present disclosure are directed to providing a device and a method for controlling regenerative braking of an electrified vehicle which may improve an electric economy by maximizing the regenerative braking of the electrified vehicle provided with dual motors.

Another aspect of the present disclosure provides a device and a method for controlling regenerative braking of an electrified vehicle which may ensure stability and economic feasibility by limiting entry into a slip occurrence region resulted from regenerative braking equal to or greater than a friction limit of a road surface.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a device configured for controlling regenerative braking of an electrified vehicle includes a drive motor configured for generating power required to drive wheels, and a controller electrically connected to the drive motor, and the controller detects vehicle data when braking the vehicle, determines whether a wheel slip of the vehicle has occurred based on the vehicle data, calculates a first regenerative braking amount based on a deceleration and a vehicle model when the wheel slip has not occurred, calculates a second regenerative braking amount based on a maximum road surface utilization rate when the wheel slip has occurred, and controls maximum regenerative braking of the drive motor based on the first regenerative braking amount or the second regenerative braking amount.

In an exemplary embodiment of the present disclosure, the vehicle data may include at least one of whether a maximum regenerative braking mode is activated, an accelerator pedal position, a front axle load, a rear axle load, a vehicle velocity, and/or a wheel speed.

In an exemplary embodiment of the present disclosure, the controller may be configured to determine whether the vehicle satisfies a maximum regenerative braking control initiation condition based on whether the maximum regenerative braking mode is activated and the accelerator pedal position.

In an exemplary embodiment of the present disclosure, the controller may estimate the wheel slip based on the vehicle velocity and the wheel speed, conclude that the wheel slip has not occurred when the wheel slip is less than a reference slip, and conclude that the wheel slip has occurred when the wheel slip is equal to or greater than the reference slip.

In an exemplary embodiment of the present disclosure, the controller may estimate a weight center point height of the vehicle mapped to a vehicle weight with reference to a lookup table stored in advance, and estimate a current deceleration of the vehicle using the vehicle velocity or the wheel speed.

In an exemplary embodiment of the present disclosure, the controller may be configured to determine a maximum regenerative braking force and a regenerative braking vehicle velocity range allowed by the drive motor, and maximize a regeneration amount by the drive motor by distributing a front axle braking force and a rear axle braking force based on the maximum regenerative braking force and a limit braking ratio between a front axle and a rear axle of the vehicle for each deceleration based on an ideal braking force diagram within the regenerative braking vehicle velocity range.

In an exemplary embodiment of the present disclosure, the controller may limit a front axle regenerative braking limit value to a current front axle control amount, and limit a rear axle regenerative braking limit value in accordance with the limit braking ratio based on the limited front axle regenerative braking limit value when only a front-wheel slip occurs.

In an exemplary embodiment of the present disclosure, the controller may limit a rear axle regenerative braking limit value to a current rear axle control amount, and limit a front axle regenerative braking limit value in accordance with the limit braking ratio based on the limited rear axle regenerative braking limit value when only a rear-wheel slip occurs.

In an exemplary embodiment of the present disclosure, the controller may limit a front axle regenerative braking limit value and a rear axle regenerative braking limit value to current control amounts of the front axle and the rear axle, respectively, and reduce an opponent axle regenerative braking limit value to a smaller value of an ideal braking force diagram-based regenerative braking limit value and a current regenerative braking limit value when a front-wheel slip and a rear-wheel slip occur.

In an exemplary embodiment of the present disclosure, the controller may be configured to determine an average of an optimal efficiency point region of an ABS as a target slip when the wheel slip occurs, and increase, decrease, or maintain a regenerative braking amount of an axle in accordance with a result of comparison between a slip of the corresponding axle and the target slip.

According to another aspect of the present disclosure, a method for controlling regenerative braking of an electrified vehicle includes detecting, by a controller, vehicle data when braking the vehicle, determining, by the controller, whether a wheel slip of the vehicle has occurred based on the vehicle data, determining, by the controller, a first regenerative braking amount based on a deceleration and a vehicle model when the wheel slip has not occurred, determining, by the controller, a second regenerative braking amount based on a maximum road surface utilization rate when the wheel slip has occurred, and controlling, by the controller, maximum regenerative braking of a drive motor based on the first regenerative braking amount or the second regenerative braking amount.

In an exemplary embodiment of the present disclosure, the vehicle data may include at least one of whether a maximum regenerative braking mode is activated, an accelerator pedal position, a front axle load, a rear axle load, a vehicle velocity, and/or a wheel speed.

In an exemplary embodiment of the present disclosure, the determining of whether the wheel slip of the vehicle has occurred may include determining, by the controller, whether the vehicle satisfies a maximum regenerative braking control initiation condition based on whether the maximum regenerative braking mode is activated and the accelerator pedal position.

In an exemplary embodiment of the present disclosure, the determining of whether the wheel slip of the vehicle has occurred may further include estimating, by the controller, the wheel slip based on the vehicle velocity and the wheel speed, concluding, by the controller, that the wheel slip has not occurred when the wheel slip is less than a reference slip, and concluding, by the controller, that the wheel slip has occurred when the wheel slip is equal to or greater than the reference slip.

In an exemplary embodiment of the present disclosure, the determining of the first regenerative braking amount may include estimating, by the controller, a weight center point height of the vehicle mapped to a vehicle weight with reference to a lookup table stored in advance, and estimating, by the controller, a current deceleration of the vehicle using the vehicle velocity or the wheel speed.

In an exemplary embodiment of the present disclosure, the determining of the first regenerative braking amount may further include determining, by the controller, a maximum regenerative braking force and a regenerative braking vehicle velocity range allowed by the drive motor, and maximizing, by the controller, a regeneration amount by the drive motor by distributing a front axle braking force and a rear axle braking force based on the maximum regenerative braking force and a limit braking ratio between a front axle and a rear axle of the vehicle for each deceleration based on an ideal braking force diagram within the regenerative braking vehicle velocity range.

In an exemplary embodiment of the present disclosure, the determining of the first regenerative braking amount may further include limiting, by the controller, a front axle regenerative braking limit value to a current front axle control amount when only a front-wheel slip occurs, and limiting, by the controller, a rear axle regenerative braking limit value in accordance with the limit braking ratio based on the limited front axle regenerative braking limit value.

In an exemplary embodiment of the present disclosure, the determining of the first regenerative braking amount may further include limiting, by the controller, a rear axle regenerative braking limit value to a current rear axle control amount when only a rear-wheel slip occurs, and limiting, by the controller, a front axle regenerative braking limit value in accordance with the limit braking ratio based on the limited rear axle regenerative braking limit value.

In an exemplary embodiment of the present disclosure, the determining of the first regenerative braking amount may further include limiting, by the controller, a front axle regenerative braking limit value and a rear axle regenerative braking limit value to current control amounts of the front axle and the rear axle, respectively, when both a front-wheel slip and a rear-wheel slip occur, and reducing, by the controller, an opponent axle regenerative braking limit value to a smaller value of an ideal braking force diagram-based regenerative braking limit value and a current regenerative braking limit value.

In an exemplary embodiment of the present disclosure, the determining of the second regenerative braking amount may include determining, by the controller, an average of an optimal efficiency point region of an ABS as a target slip, and increasing, decreasing, or maintaining, by the controller, a regenerative braking amount of an axle in accordance with a result of comparison between a slip of the corresponding axle and the target slip.

The methods and devices of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram illustrating a regenerative braking control device of an electrified vehicle according to various exemplary embodiments of the present disclosure;

FIG. 2 is a graph for illustrating a method for implementing a maximum regenerative braking torque according to various exemplary embodiments of the present disclosure;

FIG. 3 is an exemplary diagram illustrating an example of applying a regenerative braking amount to front-wheels and rear-wheels, according to various exemplary embodiments of the present disclosure;

FIG. 4 is an exemplary diagram illustrating another example of applying a regenerative braking amount to front-wheels and rear-wheels, according to various exemplary embodiments of the present disclosure;

FIG. 5 is a flowchart illustrating a regenerative braking control method of an electrified vehicle according to various exemplary embodiments of the present disclosure;

FIG. 6 is a flowchart illustrating a process of determining a maximum regenerative braking control scheme according to various exemplary embodiments of the present disclosure;

FIG. 7A and FIG. 7B are a flowchart illustrating a first regenerative braking amount determination process according to various exemplary embodiments of the present disclosure;

FIG. 8 is a flowchart illustrating a second regenerative braking amount determination process according to various exemplary embodiments of the present disclosure;

FIG. 9 is a flowchart illustrating a drive motor control process according to various exemplary embodiments of the present disclosure; and

FIG. 10 is a block diagram showing a computing system executing a regenerative braking control method of an electrified vehicle according to various exemplary embodiments of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the exemplary drawings. In adding the reference numerals to the components of each drawing, it should be noted that the identical or equivalent component is designated by the identical numeral even when they are displayed on other drawings. Furthermore, in describing the embodiment of the present disclosure, a detailed description of the related known configuration or function will be omitted when it is determined that it interferes with the understanding of the embodiment of the present disclosure.

In describing the components of the embodiment according to an exemplary embodiment of the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which the present disclosure belongs. It will be further understood that terms, such as those defined in commonly used dictionaries, should be interpreted as including a meaning which is consistent with their meaning in the context of the relevant art and will not be interpreted in an idealized or overly formal sense unless expressly so defined herein.

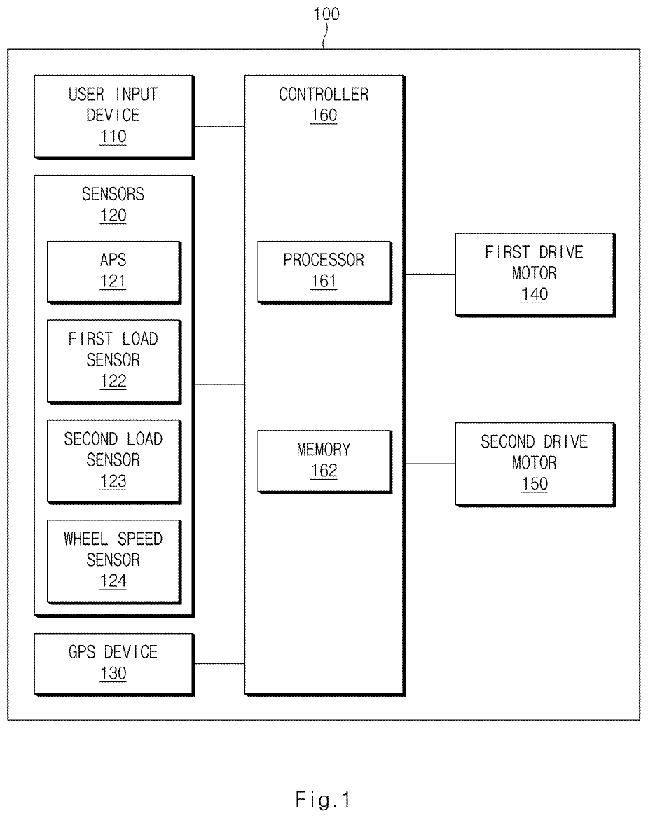

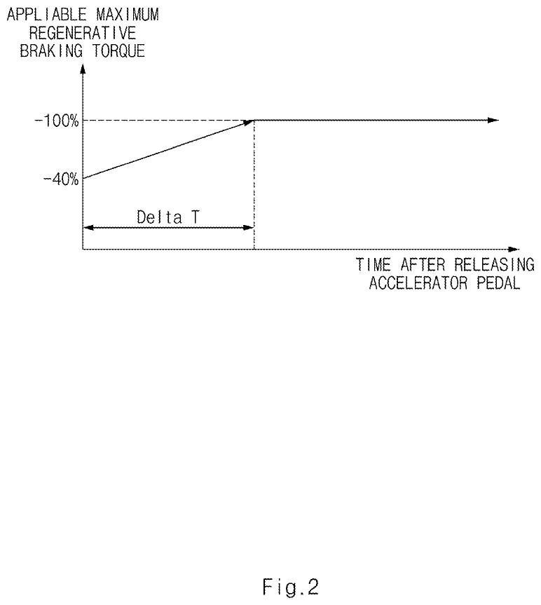

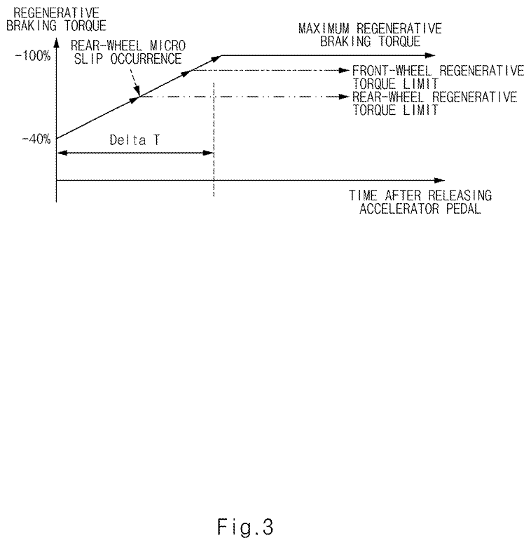

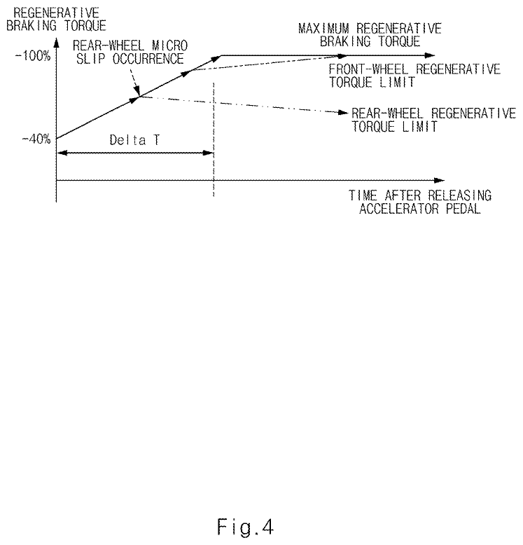

FIG. 1 is a block diagram illustrating a regenerative braking control device of an electrified vehicle according to various exemplary embodiments of the present disclosure. FIG. 2 is a graph for illustrating a method for implementing a maximum regenerative braking torque according to various exemplary embodiments of the present disclosure. FIG. 3 is an exemplary diagram illustrating an example of applying a regenerative braking amount to front-wheels and rear-wheels, according to various exemplary embodiments of the present disclosure. FIG. 4 is an exemplary diagram illustrating another example of applying a regenerative braking amount to front-wheels and rear-wheels, according to various exemplary embodiments of the present disclosure.

An electrified vehicle may include a regenerative braking control device 100 that includes two drive motors (that is, dual motors) that generate a driving force using electrical energy, and controls a regenerative braking force (a regenerative braking torque) of the dual motors.

The regenerative braking control device 100 may include a user input device 110, sensors 120, a global positioning system (GPS) device 130, a first drive motor 140, a second drive motor 150, and a controller 160.

The user input device 110 may generate data (or a signal) resulted from manipulation of a user. For example, when the user manipulates a button for setting a maximum regenerative braking mode, the user input device 110 may generate data indicating activation or deactivation of the maximum regenerative braking mode resulted from the user's manipulation of the button. The user input device 110 may be implemented as a keyboard, a keypad, a button, a switch, a touch pad, and/or a touch screen. The user input device 110 may be provided on a steering wheel, a dashboard, a center fascia, and/or a door trim.

The sensors 120 may detect vehicle information using various sensors. The sensors 120 may include an accelerator pedal sensor (APS) 121, a first load sensor 122, a second load sensor 123, and a wheel speed sensor 124, and the like. The APS 121 may measure an accelerator pedal position. The first load sensor 122 may measure a front axle load, and the second load sensor 123 may measure a rear axle load. The wheel speed sensor 124 may measure a rotational velocity of a wheel.

The Global Positioning System (GPS) device 130 may obtain a vehicle velocity, a vehicle position, and the like. The GPS device 130 determines a current position of the vehicle, that is, the vehicle position, using signals transmitted from three or more GPS satellites. The GPS device 130 may determine a distance between the satellite and the GPS device 130 using a time difference between a time when the signal is transmitted from the satellite and a time when the signal is received by the GPS device 130. The GPS device 130 may determine the current position of the vehicle using the determined distance between the satellite and the GPS device 130 and position information of the satellite included in the transmitted signal. In this connection, the GPS device 130 may determine the vehicle position using a triangulation. Furthermore, the GPS device 130 may determine the vehicle velocity by determining a vehicle position change for each unit time (e.g., 1 minute).

The first drive motor 140 and the second drive motor 150 may convert electrical energy supplied from a vehicle battery into kinetic energy to generate power required to drive wheels. The first drive motor 140 and the second drive motor 150 may adjust an output torque by adjusting a rotation direction and/or revolutions per minute (RPM) in response to an instruction of the controller 160. The first drive motor 140 may supply the power to the front-wheels and the second drive motor 150 may supply the power to the rear-wheels. The first drive motor 140 and the second drive motor 150 may be used as a generator for charging the vehicle battery by generating a counter electromotive force when a state of charge (SOC) value of the battery is insufficient or during regenerative braking. The first drive motor 140 and the second drive motor 150 convert rotational kinetic energy into the electrical energy using a rotational resistance as a braking force during braking, generating regenerative energy.

The controller 160 may be electrically connected to the user input device 110, the sensors 120, the global positioning system (GPS) 130, the first drive motor 140, and the second drive motor 150. The controller 160 may control an overall operation of the regenerative braking control device 100. The controller 160 may include a processor 161, a memory 162, and the like. The processor 161 may be implemented as at least one of an application specific integrated circuit (ASIC), a digital signal processor (DSP), a programmable logic device (PLD), a field programmable gate array (FPGA), a central processing unit (CPU), a microcontroller, and/or a microprocessor. The memory 162 may be a non-transitory storage medium storing instructions executed by the processor 161. The memory 162 may store input data and/or output data generated in response to an operation of the processor 161. Furthermore, the memory 162 may store various setting information. The memory 162 may be implemented as at least one of storage media (recording media) such as a flash memory, a hard disk, a secure digital card (SD card), a random access memory (RAM), a static random access memory (SRAM), a read only memory (ROM), a programmable read only memory (PROM), an electrically erasable and programmable ROM (EEPROM), an erasable and programmable ROM (EPROM), a register, a cache memory, and/or the like. Although the drawing shows that the memory 162 is positioned inside the controller 160, the memory 162 may be positioned outside the controller 160.

The controller 160 may detect vehicle data generated from the vehicle. The controller 160 may detect the vehicle data using the user input device 110, the sensors 120, and/or the GPS device 130 during the braking of the vehicle. The vehicle data may include information such as whether the maximum regenerative braking mode (a max economical mode) is activated, the accelerator pedal position, the front axle load, the rear axle load, GPS-based vehicle velocity and/or wheel speed, and the like.

The controller 160 may determine whether the vehicle satisfies a maximum regenerative braking control initiation condition based on the vehicle data. The controller 160 may determine whether to initiate maximum regenerative braking control based on whether the maximum regenerative braking mode is activated and the accelerator pedal position information. When the vehicle satisfies the maximum regenerative braking control initiation condition, the controller 160 may determine to initiate the maximum regenerative braking control. For example, the controller 160 may determine to initiate the maximum regenerative braking control when a maximum regenerative braking function (the mode) is activated and the accelerator pedal is not depressed by the user. The controller 160 may determine to terminate the maximum regenerative braking control when the vehicle does not satisfy the maximum regenerative braking control initiation condition. For example, when the maximum regenerative braking function is activated but the accelerator pedal is being manipulated by the user, the controller 160 may determine not to initiate the maximum regenerative braking control.

The controller 160 may determine whether a wheel slip resulted from the braking has occurred based on the vehicle velocity and the wheel speed. The wheel slip refers to a state in which the wheel speed is low compared to the vehicle velocity resulted from the generation of a braking force equal to or greater than a friction limit of a road surface. To determine whether the wheel slip has occurred, the controller 160 may estimate (determine) a slip value (a difference between the vehicle velocity and the wheel speed) of the wheel based on the vehicle velocity and the wheel speed. The controller 160 may determine whether the wheel slip has occurred based on the estimated slip value. When the estimated slip value is less than a preset reference slip, the controller 160 may determine that the wheel slip has not occurred. When the estimated slip value is equal to or greater than the preset reference slip, the controller 160 may determine that the wheel slip has occurred.

The controller 160 may determine a maximum regenerative braking control scheme based on whether the wheel slip has occurred. The maximum regenerative braking control schemes may be classified into linear control (a first control scheme) and non-linear control (a second control scheme). The linear control, which is control in a linear region where the wheel slip does not occur (a section in which an increase in the regenerative braking force is reflected as an increase in a deceleration), may be utilized in most travel because of being able to achieve improvement in electric economy by actively using of a control amount with a concept of applying regenerative braking within the friction limit of the road surface. The non-linear control is control in a controllable insecure region (a non-linear region) in which a small wheel slip equal to or greater than the reference slip has occurred. The controller 160 may select the first control scheme when it is determined that the wheel slip has not occurred, and select the second control scheme when it is determined that the wheel slip has occurred.

When the first control scheme is selected, the controller 160 may estimate a weight center point height and the deceleration of the vehicle required for the maximum regenerative braking control based on the first control scheme. The controller 160 may estimate the weight center point height by referring to a lookup table previously stored in the memory 162. In the lookup table, a weight center point height mapped for each vehicle weight may be defined or a weight center point height based on the front axle load and the rear axle load may be defined. For example, the controller 160 may determine the weight center point height mapped to the vehicle weight or the weight center point height mapped to the front axle load and the rear axle load as the weight center point height of the vehicle by referring to the lookup table. The controller 160 may estimate (determine) a current deceleration of the vehicle using the GPS device 130 and the wheel speed sensor 124. The controller 160 may determine the current deceleration based on the vehicle velocity obtained by the GPS device 130 when the GPS signal is valid. The controller 160 may determine the current deceleration based on the wheel speed measured by the wheel speed sensor 124 when the GPS signal is not valid.

When the second control scheme is selected, the controller 160 may determine whether the maximum regenerative braking control is possible. The controller 160 may determine whether a slip ratio of the wheel is within a preset reference slip ratio range. The controller 160 may determine that the maximum regenerative braking control is possible when the slip ratio is within the reference slip ratio range. The controller 160 may determine that the maximum regenerative braking control is not possible when the slip ratio is out of the reference slip ratio range. In the present connection, the reference slip ratio range, which is a maximum efficiency point region (a sweet-spot) (an anti-lock brake system (ABS) control region by the wheel slip) determined from evaluation of tire characteristics, may be an optimal slip ratio range that allows the maximum regenerative braking control in the wheel slip occurrence situation.

When the first control scheme is selected, the controller 160 may determine a linear region regenerative braking amount (a first regenerative braking amount). To determine the first regenerative braking amount, first, the controller 160 may determine the maximum regenerative braking force (the maximum regenerative braking torque) based on current states of the drive motors 140 and 150 and a driving situation (e.g., motor thermal management, a battery charging situation, a resistor operation situation based on full charging of the battery, and the like). The controller 160 may receive the maximum regenerative braking force from the drive motors 140 and 150. The maximum regenerative braking force may be a limit of the regenerative braking torque (a reverse torque) that the drive motors 140 and 150 may tolerate in real time. In other words, the maximum regenerative braking force may be −70% or −80% rather than −100% unconditionally. A delay time by delta T may be consumed (see FIG. 2) to reach the maximum regenerative braking torque from a maximum regenerative braking starting torque (e.g., −40%) so that unnecessary wheel slip does not occur by an occurrence of overshoot resulted from a fast responsiveness of the motor when determining the maximum regenerative braking force.

Furthermore, the controller 160 may determine a regenerative braking vehicle velocity range in which the maximum regenerative braking control may be applied. The controller 160 may receive the regenerative braking vehicle velocity range from the drive motors 140 and 150. The regenerative braking vehicle velocity range may be determined based on motor characteristics. Because a regenerative energy generation rate (a regeneration rate) of the drive motors 140 and 150 decreases rapidly in a low rotation region, when it is to release the regenerative braking control early and stop the vehicle stably with a driver brake, it is possible to extend the regenerative braking vehicle velocity range to a velocity at which a net regeneration rate, excluding driver heterogeneity, collision avoidance resulted from a decrease of a low-speed region regeneration rate, becomes 0. Furthermore, brake loosening, buzzing, and the like caused by the decrease in the regeneration rate may be improved through separate main brake intervention.

The controller 160 may distribute the maximum regenerative braking force and a maximum braking force applied to the front axle and the rear axle within the regenerative braking vehicle velocity range. The controller 160 may determine a maximum regeneration amount and a maximum regenerative braking using vehicle velocity based on the current deceleration. The controller 160 may determine the maximum braking forces of the front-wheels and the rear-wheels of a dynamic model for each deceleration.

When the maximum regenerative braking force, that is, the maximum regenerative braking torque is applied equally to the front axle and the rear axle, a center of gravity of the vehicle may be shifted toward the front axle and may always cause rear-wheel slip, which may impair improvement of maximum electric economy, or the maximum regenerative braking mode itself may not be able to be performed when the slip becomes great. Thus, the controller 160 may apply the maximum regenerative braking force to the front axle and the rear axle only when the wheel slip is ideally ‘0’. When a micro slip occurs on the front axle and/or rear axle, the controller 160 may determine a control amount for each axis (the maximum braking force of the front-wheels and the maximum braking force of the rear-wheels) based on the current deceleration of the vehicle and a vehicle model (the dynamics model). The controller 160 may limit a regeneration amount of the axle on which the micro slip (the wheel slip less than the reference slip) has occurred not to increase more than a regeneration amount at the current deceleration. Furthermore, the controller 160 may determine a braking force of an axle on which the slip has not occurred based on a ratio of an abnormal braking force of the front axle and the rear axle considering a dynamic load of the vehicle. The controller 160 may determine ideal front-wheel braking force B_{f} and rear-wheel braking force Bᵣ using [Equation 1] and [Equation 2]. It is ideal that the front-wheel braking force B_{f} and the rear-wheel braking force Bᵣ are proportional to distribution of the dynamic load of the vehicle.

$${B}_{f} = μ {W}_{f} = \frac{a}{g} ( {W}_{fs} + W \cdot \frac{a}{g} \cdot \frac{h}{l} ) \qquad [ Equation 1 ]$$

$${B}_{r} = μ {W}_{r} = \frac{a}{g} ( {W}_{rs} + W \cdot \frac{a}{g} \cdot \frac{h}{l} ) \qquad [ Equation 2 ]$$

Here, “a” is the deceleration of the vehicle, “W” is the vehicle weight, W_{f} is a front-wheel dynamic load during the braking, Wᵣ is a rear-wheel dynamic load during the braking, W_{fs} is a front-wheel static load, Wᵣₛ is a rear-wheel static load, “g” is a gravitational acceleration, “h” is the weight center point height, and “l” is a distance between the axles.

For the front-wheel braking force B_{f} and the rear-wheel braking force Bᵣ, the higher the deceleration and the higher the weight center point, the higher the proportion of the front-wheel braking force and the lower the proportion of the rear-wheel braking force. Accordingly, the controller 160 may distribute the maximum regenerative braking force to the front-wheels and the rear-wheels based on a limit braking ratio between the front axle and the rear axle for each deceleration based on an ideal braking force diagram. The ideal braking force diagram may be defined as a curve representing the ideal front-wheel and rear-wheel braking forces based on the deceleration.

As an exemplary embodiment of the present disclosure, the controller 160 may determine the maximum regenerative braking torque and the maximum regenerative braking using vehicle velocity based on the current deceleration when the micro slip has not occurred on the front axle and the rear axle (that is, slip=0). The controller 160 may apply the determined maximum regenerative braking torque and maximum regenerative braking using vehicle velocity to the front axle and the rear axle.

As an exemplary embodiment of the present disclosure, when the micro slip has occurred on the front axle, the controller 160 may limit a front axle regenerative braking torque (front-wheel braking force) limit value to the regenerative braking torque based on the current deceleration. When the deceleration of the vehicle changes, the controller 160 may estimate and change the front axle regenerative braking torque limit value based on an ideal braking force diagram-based braking force ratio between the front-wheels and the rear-wheels. Furthermore, the controller 160 may limit a maximum value of a rear axle regenerative braking torque (a rear axle regenerative braking torque limit value) relative to the limited front axle regenerative braking torque (the front axle regenerative braking torque limit value).

As an exemplary embodiment of the present disclosure, when the micro slip has occurred on the rear axle, the controller 160 may limit the rear axle regenerative braking torque limit value to the rear axle regenerative braking torque (the rear-wheel braking force) based on the current deceleration of the vehicle. The controller 160 may limit a maximum value of the front axle regenerative braking torque (the front axle regenerative braking torque limit value) based on the limited rear axle regenerative braking torque (the rear axle regenerative braking torque limit value). Referring to FIG. 3, when the rear-wheel micro slip occurs while controlling the front-wheel and rear-wheel regenerative braking torques based on the ideal braking force diagram in a state in which the vehicle deceleration is kept constant, the controller 160 may limit the rear axle regenerative braking torque limit value by setting the rear axle regenerative braking torque limit value as the rear axle regenerative braking torque based on the current deceleration. Furthermore, the controller 160 may limit the front axle regenerative braking torque limit value based on the ideal braking force diagram-based braking force ratio between the front-wheel and the rear-wheel braking force relative to the rear axle regenerative braking torque. The controller 160 may estimate and change the rear axle regenerative braking torque limit value based on the ideal braking force diagram when the deceleration of the vehicle is changed. Referring to FIG. 4, when the vehicle deceleration gradually increases, the controller 160 may estimate and change the rear axle regenerative braking torque limit value based on the ideal braking force diagram-based braking force ratio between the front-wheel and the rear-wheel braking force.

As an exemplary embodiment of the present disclosure, when the micro slip occurs on both the front axle and the rear axle, the controller 160 may limit the front axle regenerative braking torque limit value and the rear axle regenerative braking torque limit value to the front axle regenerative braking torque and the rear axle regenerative braking torque based on the current deceleration of the vehicle, respectively. The controller 160 may estimate and change the regenerative braking torque limit value of each axle based on the ideal braking force diagram when the vehicle deceleration is changed. The controller 160 may reduce the front axle regenerative braking torque limit value to a smaller one of the front axle regenerative braking torque based on the rear axle-based ideal braking force diagram and the front axle regenerative braking torque limit value (the limited front axle regenerative braking torque). Furthermore, the controller 160 may reduce the rear axle regenerative braking torque limit value to a smaller one of the rear axle regenerative braking torque based on the front axle-based ideal braking force diagram and the rear axle regenerative braking torque limit value (the limited rear axle regenerative braking torque).

In one example, when the second control scheme is selected, the controller 160 may determine a non-linear region regenerative braking amount (a second regenerative braking amount) based on a maximum road surface utilization rate. The non-linear region, which is a region where a road surface friction limit begins to be exceeded, is generally the ABS control region by the slip, and is a section where the regenerative braking may be terminated during an ABS operation. The controller 160 may perform the maximum regenerative braking control with priority over the ABS to maximize the regenerative braking force. The controller 160 may give the priority to the ABS when the wheel slip of the vehicle (a vehicle slip) is out of the maximum efficiency point region. The controller 160 may control, as a target, optimization of tire traction efficiency rather than minimization of the slip during the maximum regenerative braking control based on the second control scheme. The controller 160 may perform feedback control to follow a target regenerative braking force based on the maximum efficiency point region. The controller 160 may set a slip average of the maximum efficiency point region as an optimal slip, that is, a target slip. The controller 160 may compare the wheel slip of the vehicle with the target slip during the maximum regenerative braking control, and may increase or decrease the regeneration amount based on the comparison result. In the present connection, the controller 160 may perform separate control based on a slip situation of each axle.

The controller 160 may transmit the regenerative braking amount (the regenerative braking torque) determined according to the first control scheme or the second control scheme to the drive motors 140 and 150. Furthermore, the controller 160 may receive feedback on the regenerative braking torque output from the drive motors 140 and 150. The controller 160 may control the regenerative braking torque of the drive motors 140 and 150 by comparing a regenerative braking torque (an input regenerative braking torque) applied (input) to the drive motors 140 and 150 with a regenerative braking torque (an output regenerative braking torque) output from the drive motors 140 and 150. When the input regenerative braking torque is greater than the output regenerative braking torque, the controller 160 may increase regenerative energy output by increasing the output regenerative braking torque of the drive motors 140 and 150. When the input regenerative braking torque is less than the output regenerative braking torque, the controller 160 may reduce the regenerative energy output by reducing the output regenerative braking torque of the drive motors 140 and 150. When the input regenerative braking torque and the output regenerative braking torque match, the controller 160 may maintain the regenerative energy output by maintaining the output regenerative braking torque of the drive motors 140 and 150.

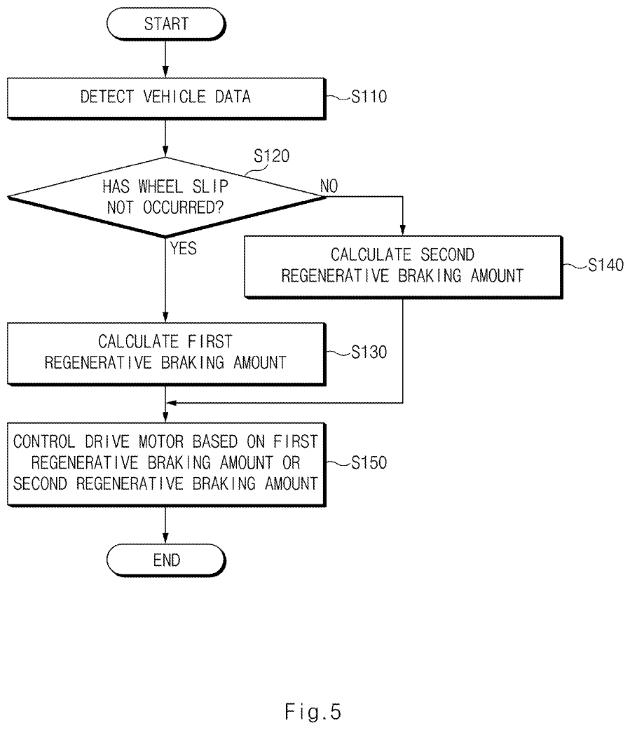

FIG. 5 is a flowchart illustrating a regenerative braking control method of an electrified vehicle according to various exemplary embodiments of the present disclosure.

The controller 160 may detect the vehicle data during the vehicle braking (S110). The controller 160 may receive, from the user input device 110, whether the maximum regenerative braking control is activated. The controller 160 may obtain the accelerator pedal position, the front axle load, the rear axle load, and/or the wheel speed through the sensors 120. The controller 160 may detect the vehicle velocity using the GPS device 130.

The controller 160 may determine whether the wheel slip has occurred according to the vehicle data (S120). The controller 160 may determine whether the wheel slip has occurred based on the vehicle velocity and the wheel speed. The controller 160 may determine that the wheel slip has not occurred when the difference between the vehicle velocity and the wheel speed is less than the reference slip. In one example, the controller 160 may determine that the wheel slip has occurred when the difference between the vehicle velocity and the wheel speed is equal to or greater than the reference slip.

When it is determined that the wheel slip has not occurred, the controller 160 may determine the first regenerative braking amount according to the first control scheme (S130).

When it is determined that the wheel slip has occurred, the controller 160 may determine the second regenerative braking amount according to the second control scheme (S140).

The controller 160 may control the drive motor 140 and/or 150 according to the first regenerative braking amount or the second regenerative braking amount (S150). The controller 160 may control the drive motor 140 and/or 150 to increase/decrease a braking pressure applied to each wheel. In the present connection, the controller 160 may perform evasive steering and transmit a command through communication with a platooning vehicle.

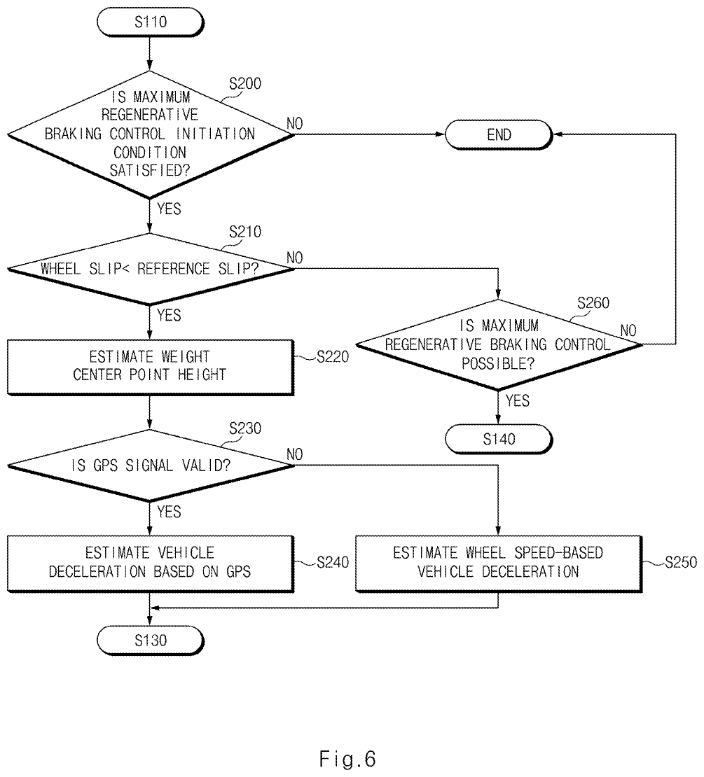

FIG. 6 is a flowchart illustrating a process of determining a maximum regenerative braking control scheme according to various exemplary embodiments of the present disclosure.

The controller 160 may determine whether the vehicle satisfies the maximum regenerative braking control initiation condition (S200). The controller 160 may determine whether to initiate the maximum regenerative braking control based on whether the maximum regenerative braking mode is activated and the accelerator pedal position information included in the vehicle data detected in S100 of FIG. 5. When the vehicle satisfies the maximum regenerative braking control initiation condition, the controller 160 may determine to initiate the maximum regenerative braking control. For example, the controller 160 may determine to initiate the maximum regenerative braking control when the maximum regenerative braking function is activated and the accelerator pedal is not depressed by the user. The controller 160 may determine to terminate the maximum regenerative braking control when the vehicle does not satisfy the maximum regenerative braking control initiation condition. For example, when the maximum regenerative braking function is activated but the accelerator pedal is being depressed by the user, the controller 160 may determine not to initiate the maximum regenerative braking control.

The controller 160 may determine whether the wheel slip of the vehicle is less than the reference slip when the maximum regenerative braking control initiation condition is satisfied (S210). The controller 160 may determine the wheel slip (the difference between the vehicle velocity and the wheel speed) using the vehicle velocity and the wheel speed in the vehicle data. The controller 160 may determine that the wheel slip has not occurred when the wheel slip is less than the reference slip. The controller 160 may conclude that the wheel slip has occurred when the wheel slip is equal to or greater than the reference slip. The reference slip may be set in advance by a system designer.

When the wheel slip is less than the reference slip, the controller 160 may estimate the weight center point height of the vehicle (S220). The controller 160 may estimate the weight center point height based on the vehicle weight (or the front axle load and the rear axle load) by referring to the lookup table pre-stored in the memory 162. In the lookup table, the weight center point height mapped for each vehicle weight may be defined or the weight center point height based on the front axle load and the rear axle load may be defined.

The controller 160 may determine whether the GPS signal of the GPS device 130 is valid (S230). Because the controller 160 determines whether the GPS device 130 operates normally, whether the GPS signal is valid may be determined.

When the GPS signal is valid, the controller 160 may estimate the vehicle deceleration according to the GPS information (S240). The controller 160 may determine the current deceleration of the vehicle using the vehicle velocity transmitted from the GPS device 130.

When the GPS signal is not valid in S230, the controller 160 may estimate the wheel speed-based vehicle deceleration (S250). The controller 160 may determine the current deceleration of the vehicle based on the wheel speed measured by the wheel speed sensor 124.

When the wheel slip is equal to or greater than the reference slip in S210, the controller 160 may determine whether the maximum regenerative braking control of the vehicle is possible based on the wheel slip (S260). The controller 160 may determine a wheel slip ratio based on the wheel slip. The controller 160 may determine whether the wheel slip ratio is within the reference slip ratio range. In the present connection, the reference slip ratio range, which is the maximum efficiency point region (the anti-lock brake system (ABS) control region by the wheel slip) determined from the evaluation of the tire characteristics, may be the optimal slip ratio range that allows the maximum regenerative braking control in the wheel slip occurrence situation. The controller 160 may determine that the maximum regenerative braking control is possible when the wheel slip ratio is within the reference slip ratio range. When it is determined that the maximum regenerative braking control is possible, the controller 160 may perform S140. The controller 160 may determine that the maximum regenerative braking control is not possible when the slip ratio is out of the reference slip ratio range. The controller 160 may terminate the maximum regenerative braking control when it is determined that the maximum regenerative braking control is not possible.

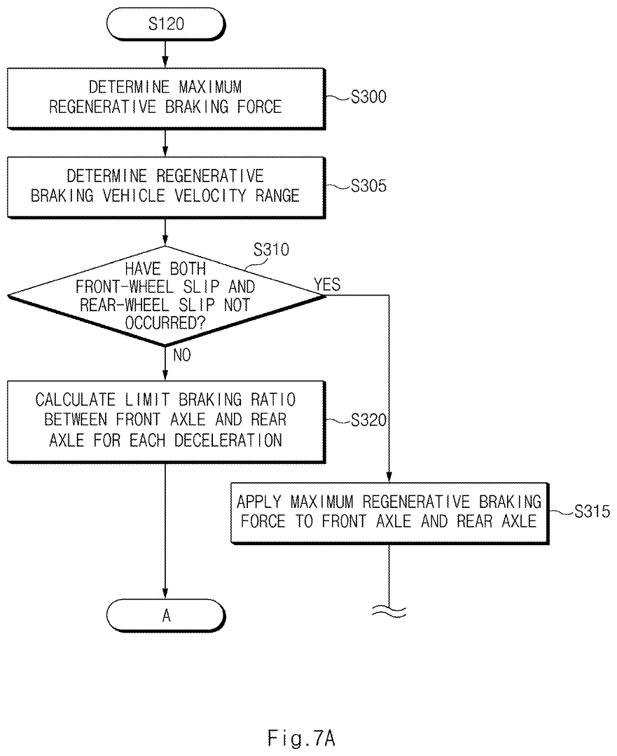

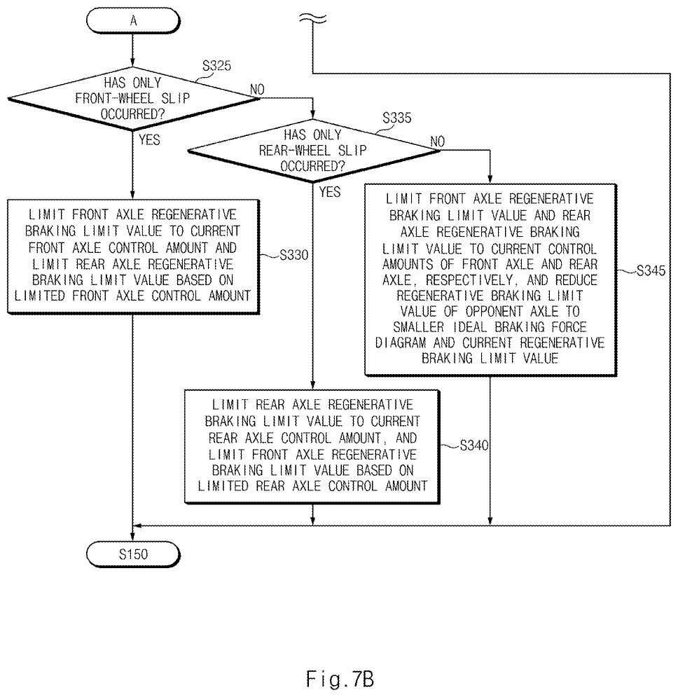

FIG. 7A and FIG. 7B are a flowchart illustrating a first regenerative braking amount determination process according to various exemplary embodiments of the present disclosure. The exemplary embodiment describes a process of determining the regenerative braking amount for the maximum regenerative braking control (the first control scheme) in the linear region where the wheel slip less than the reference slip occurs.

First, the controller 160 may determine the maximum regenerative braking force (the maximum regenerative braking torque) based on the current states of the drive motors 140 and 150 and the driving situation (e.g., the motor thermal management, the battery charging situation, the resistor operation situation based on the full charging of the battery, and the like) (S300). The controller 160 may receive the maximum regenerative braking force from the drive motors 140 and 150. The maximum regenerative braking force may be the limit of the regenerative braking torque that the drive motors 140 and 150 may tolerate in real time. For example, the maximum regenerative braking force may be −70% or −80% rather than −100% unconditionally. The delay time by delta T may be consumed (see FIG. 2) to reach the maximum regenerative braking torque from the maximum regenerative braking starting torque (e.g., −40%) so that the unnecessary wheel slip does not occur by the occurrence of the overshoot resulted from the fast responsiveness of the motor when determining the maximum regenerative braking force.

The controller 160 may determine the regenerative braking vehicle velocity range in which the maximum regenerative braking control may be applied (S305). The controller 160 may receive the regenerative braking vehicle velocity range from the drive motors 140 and 150. The regenerative braking vehicle velocity range may be determined based on the motor characteristics.

The controller 160 may determine whether both the front-wheel slip (a front axle slip) and the rear-wheel slip (a rear axle slip) have not occurred (S310). The controller 160 may determine whether both the front-wheel slip and the rear-wheel slip are ideally ‘0’.

When both the front-wheel slip and the rear-wheel slip have not occurred, the controller 160 may apply the maximum regenerative braking force to the front axle and the rear axle (S315). The controller 160 may determine the maximum regenerative braking force based on the current deceleration. The controller 160 may apply the determined maximum regenerative braking force to each of the front axle and the rear axle.

When at least one of the front-wheel slip and the rear-wheel slip is not in the non-occurrence state in S315, the controller 160 may determine the limit braking ratio between the front axle and the rear axle for each deceleration (S320). The controller 160 may determine a ratio between a front-wheel braking force limit value and a rear-wheel braking force limit value for each deceleration using [Equation 1] and [Equation 2].

The controller 160 may determine whether only the front-wheel slip has occurred (S325). In the present connection, the front-wheel slip may be the micro slip less than the reference slip.

When it is determined in S325 that only the front-wheel slip has occurred, the controller 160 may limit the front axle regenerative braking limit value to a current front axle control amount and limit the rear axle regenerative braking limit value based on the limited front axle control amount (S330). In other words, the controller 160 may limit the front axle regenerative braking torque limit value to the regenerative braking torque (the regenerative braking amount and the regenerative braking force) based on the current deceleration. The controller 160 may limit the rear axle regenerative braking torque limit value (the maximum value) based on the limited front axle regenerative braking torque limit value. In the present connection, the controller 160 may determine the rear axle regenerative braking torque limit value based on an ideal braking force diagram-based limit braking force ratio between the front-wheels and the rear-wheels based on the current deceleration.

When it is not determined in S325 that only the front-wheel slip has occurred, the controller 160 may determine whether only the rear-wheel slip has occurred (S335). In the present connection, the rear-wheel slip may be the micro slip less than the reference slip.

When it is identified in the S335 that only the rear-wheel slip has occurred, the controller 160 may limit the rear axle regenerative braking limit value to a current rear axle control amount, and limit the front axle regenerative braking limit value based on the limited rear axle control amount (S340). The controller 160 may limit the rear axle regenerative braking torque limit value to the regenerative braking torque based on the current deceleration. The controller 160 may limit the front axle regenerative braking torque limit value based on the limited rear axle regenerative braking torque limit value. In the present connection, the controller 160 may determine (determine) the front axle regenerative braking torque limit value based on the ideal braking force diagram-based limit braking force ratio between the front-wheels and the rear-wheels based on the current deceleration.

When it is not identified in the S335 that only the rear-wheel slip has occurred, the controller 160 may limit the front axle regenerative braking limit value and the rear axle regenerative braking limit value to current control amounts of the front axle and the rear axle, respectively, and reduce a regenerative braking limit value of an opponent axle corresponding to the front axle and the rear axle to a smaller value of a regenerative braking limit value based on the ideal braking force diagram and a current regenerative braking limit value (S345). When the micro slip less than the reference slip occurs on both the front-wheels and the rear-wheels, the controller 160 may limit the front axle regenerative braking torque limit value and the rear axle regenerative braking torque limit value to the front axle regenerative braking torque and the rear axle regenerative braking torque based on the current deceleration of the vehicle, respectively. The controller 160 may estimate and change the regenerative braking torque limit value of each axle based on the ideal braking force diagram when the vehicle deceleration is changed. The controller 160 may reduce the front axle regenerative braking torque limit value to the smaller one of the front axle regenerative braking torque based on the rear axle-based ideal braking force diagram and the front axle regenerative braking torque limit value (the limited front axle regenerative braking torque). Furthermore, the controller 160 may reduce the rear axle regenerative braking torque limit value to the smaller one of the rear axle regenerative braking torque based on the front axle-based ideal braking force diagram and the rear axle regenerative braking torque limit value (the limited rear axle regenerative braking torque).

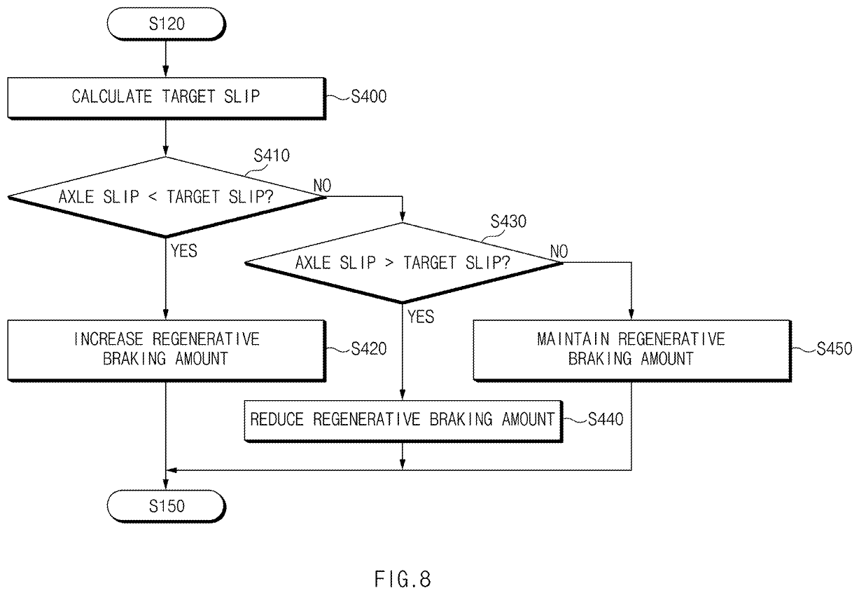

FIG. 8 is a flowchart illustrating a second regenerative braking amount determination process according to various exemplary embodiments of the present disclosure. The exemplary embodiment describes a process of determining the regenerative braking amount for the maximum regenerative braking control (the second control scheme) in the non-linear region where the wheel slip equal to or greater than the reference slip occurs. The non-linear region, which is the region where the road surface friction limit begins to be exceeded, corresponds to the ABS control region by the slip. The controller 160 may control the maximum regenerative braking with the priority over the ABS to maximize the regenerative braking force in the non-linear region.

First, the controller 160 may determine the slip average of the maximum efficiency point region (that is, the ABS control region) as the target slip (S400).

The controller 160 may determine whether the axle slip (the front axle slip and the rear axle slip) is less than the target slip (S410).

When the axle slip is less than the target slip, the controller 160 may increase the regenerative braking amount of the corresponding axle (S420). The controller 160 may increase the regenerative braking torque of the drive motors 140 and 150, which is mapped to the axle on which the slip less than the target slip has occurred.

When the axle slip is not less than the target slip in S410, the controller 160 may determine whether the axle slip exceeds the target slip (S430).

When the axle slip exceeds the target slip, the controller 160 may reduce the regenerative braking amount of the corresponding axle (S440). The controller 160 may reduce the regenerative braking amount distributed to the axle on which the slip exceeding the target slip has occurred. In other words, the controller 160 may reduce the regenerative braking torque of the drive motors 140 and 150.

When the axle slip does not exceed the target slip in the S430, the regenerative braking amount of the corresponding axle may be maintained (S450). When the axle slip matches the target slip, the controller 160 may maintain the regenerative braking torque of the drive motors 140 and 150 by maintaining the regenerative braking amount distributed to the corresponding axle.

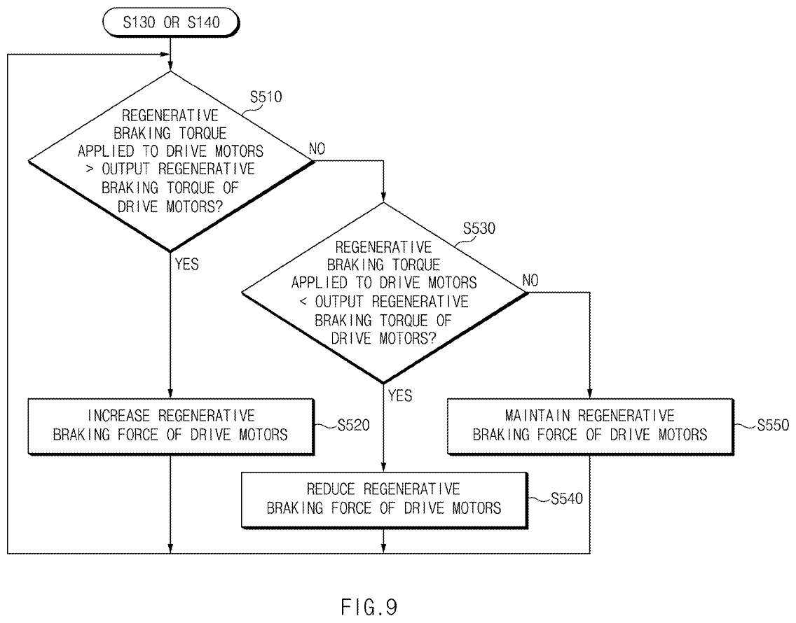

FIG. 9 is a flowchart illustrating a drive motor control process according to various exemplary embodiments of the present disclosure.

The controller 160 may control the drive motors 140 and 150 based on the regenerative braking amount (the regenerative braking torque) determined according to the first control scheme or the second control scheme. The controller 160 may transmit the regenerative braking amount distributed to the axle (the front axle and the rear axle) to the drive motors 140 and 150 matching with the corresponding axle.

The controller 160 may determine whether the regenerative braking torque applied to the drive motors 140 and 150 exceeds the output regenerative braking torque of the drive motors 140 and 150 (S510).

When the regenerative braking torque applied to the drive motors 140 and 150 exceeds the output regenerative braking torque of the drive motors 140 and 150, the controller 160 may increase the regenerative braking force of the drive motors 140 and 150 (S520). That is, the controller 160 may increase the regenerative braking torque of the drive motors 140 and 150.

When the regenerative braking torque applied to the drive motors 140 and 150 does not exceed the output regenerative braking torque of the drive motors 140 and 150 in 520, the controller 160 may determine whether the regenerative braking torque applied to the drive motors 140 and 150 is less than the output regenerative braking torque of the drive motors 140 and 150 (S530).

When the regenerative braking torque applied to the drive motors 140 and 150 is less than the output regenerative braking torque of the drive motors 140 and 150, the controller 160 may reduce the regenerative braking force of the drive motors 140 and 150 (S540). The controller 160 may instruct the drive motors 140 and 150 to reduce the regenerative braking torque.

When the regenerative braking torque applied to the drive motors 140 and 150 is not less than the output regenerative braking torque of the drive motors 140 and 150 in S530, the controller 160 may maintain the regenerative braking force of the drive motors 140 and 150 (S550). When the regenerative braking torque applied to the drive motors 140 and 150 matches the output regenerative braking torque of the drive motors 140 and 150, the controller 160 may instruct the drive motors 140 and 150 to maintain the current regenerative braking force.

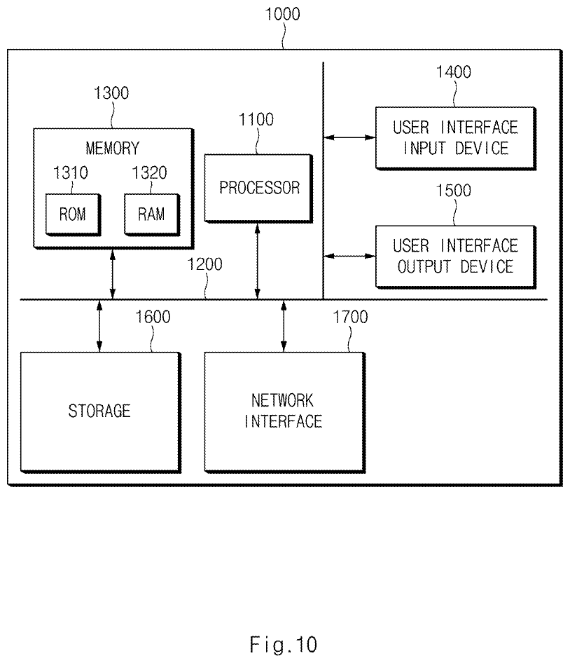

FIG. 10 is a block diagram showing a computing system executing a regenerative braking control method of an electrified vehicle according to various exemplary embodiments of the present disclosure.

With reference to FIG. 10, a computing system 1000 may include at least one processor 1100, a memory 1300, a user interface input device 1400, a user interface output device 1500, storage 1600, and a network interface 1700 connected via a bus 1200.

The processor 1100 may be a central processing unit (CPU) or a semiconductor device that performs processing on commands stored in the memory 1300 and/or the storage 1600. The memory 1300 and the storage 1600 may include various types of volatile or non-volatile storage media. For example, the memory 1300 may include a Read-Only Memory (ROM) 1310 and a Random Access Memory (RAM) 1320.

Thus, the operations of the method or the algorithm described in connection with the exemplary embodiments included herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM. The exemplary storage medium is coupled to the processor 1100, which may read information from, and write information to, the storage medium. In another method, the storage medium may be integral with the processor 1100. The processor 1100 and the storage medium may reside within an application specific integrated circuit (ASIC). The ASIC may reside within the user terminal. In another method, the processor and the storage medium may reside as individual components in the user terminal.

The description above is merely illustrative of the technical idea of the present disclosure, and various modifications and changes may be made by those skilled in the art without departing from the essential characteristics of the present disclosure. Therefore, the exemplary embodiments included in the present disclosure are not intended to limit the technical idea of the present disclosure but to illustrate the present disclosure, and the scope of the technical idea of the present disclosure is not limited by the embodiments. The scope of the present disclosure may be construed as being covered by the scope of the appended claims, and all technical ideas falling within the scope of the claims may be construed as being included in the scope of the present disclosure.

According to an exemplary embodiment of the present disclosure, the electric economy may be improved by maximizing the regenerative braking in consideration of the structure of the electrified vehicle provided with the dual motors.

Furthermore, according to an exemplary embodiment of the present disclosure, it is possible to improve the electric economy while securing the stability and the economic feasibility even in the slip occurrence region resulted from the regenerative braking equal to or greater than the friction limit of the road surface.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of predetermined exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A device for controlling regenerative braking of an electrified vehicle, the device comprising:
a drive motor configured for generating power required to drive wheels of the vehicle; and
a controller electrically connected to the drive motor,
wherein the controller is configured to:
detect vehicle data when braking the vehicle;
determine whether a wheel slip of the vehicle has occurred based on the vehicle data;
determine a first regenerative braking amount based on a deceleration and a vehicle model when the wheel slip has not occurred;
determine a second regenerative braking amount based on a maximum road surface utilization rate when the wheel slip has occurred; and
control maximum regenerative braking of the drive motor based on the first regenerative braking amount or the second regenerative braking amount.

2. The device of claim 1, wherein the vehicle data includes at least one of whether a maximum regenerative braking mode is activated, an accelerator pedal position, a front axle load, a rear axle load, a vehicle velocity, and/or a wheel speed.

3. The device of claim 2, wherein the controller is configured to determine whether the vehicle satisfies a maximum regenerative braking control initiation condition based on whether the maximum regenerative braking mode is activated and the accelerator pedal position.

4. The device of claim 2, wherein the controller is configured to:
estimate the wheel slip based on the vehicle velocity and the wheel speed;
conclude that the wheel slip has not occurred when the wheel slip is less than a reference slip; and
conclude that the wheel slip has occurred when the wheel slip is equal to or greater than the reference slip.

5. The device of claim 2, wherein the controller is configured to:
estimate a weight center point height of the vehicle mapped to a vehicle weight with reference to a lookup table stored in advance; and
estimate a current deceleration of the vehicle using the vehicle velocity or the wheel speed.

6. The device of claim 5, wherein the controller is configured to:
determine a maximum regenerative braking force and a regenerative braking vehicle velocity range allowed by the drive motor; and
maximize a regeneration amount by the drive motor by distributing a front axle braking force and a rear axle braking force based on the maximum regenerative braking force and a limit braking ratio between a front axle and a rear axle of the vehicle for each deceleration based on an ideal braking force diagram within the regenerative braking vehicle velocity range.

7. The device of claim 6, wherein the controller is configured to limit a front axle regenerative braking limit value to a current front axle control amount, and limit a rear axle regenerative braking limit value in accordance with the limit braking ratio based on the limited front axle regenerative braking limit value when only a front-wheel slip occurs.

8. The device of claim 6, wherein the controller is configured to limit a rear axle regenerative braking limit value to a current rear axle control amount, and limit a front axle regenerative braking limit value in accordance with the limit braking ratio based on the limited rear axle regenerative braking limit value when only a rear-wheel slip occurs.

9. The device of claim 6, wherein the controller is configured to limit a front axle regenerative braking limit value and a rear axle regenerative braking limit value to current control amounts of the front axle and the rear axle, respectively, and reduce an opponent axle regenerative braking limit value to a smaller value of an ideal braking force diagram-based regenerative braking limit value and a current regenerative braking limit value when a front-wheel slip and a rear-wheel slip occur.

10. The device of claim 1, wherein the controller is configured to:
determine an average of an optimal efficiency point region of an anti-lock brake system (ABS) as a target slip when the wheel slip occurs; and
increase, decrease, or maintain a regenerative braking amount of an axle in accordance with a result of comparison between a slip of the corresponding axle and the target slip.

11. A method for controlling regenerative braking of an electrified vehicle, the method comprising:
detecting, by a controller, vehicle data when braking the vehicle;
determining, by the controller, whether a wheel slip of the vehicle has occurred based on the vehicle data;
determining, by the controller, a first regenerative braking amount based on a deceleration and a vehicle model when the wheel slip has not occurred;
determining, by the controller, a second regenerative braking amount based on a maximum road surface utilization rate when the wheel slip has occurred; and
controlling, by the controller, maximum regenerative braking of a drive motor based on the first regenerative braking amount or the second regenerative braking amount.

12. The method of claim 11, wherein the vehicle data includes at least one of whether a maximum regenerative braking mode is activated, an accelerator pedal position, a front axle load, a rear axle load, a vehicle velocity, and/or a wheel speed.

13. The method of claim 12, wherein the determining of whether the wheel slip of the vehicle has occurred includes:
determining, by the controller, whether the vehicle satisfies a maximum regenerative braking control initiation condition based on whether the maximum regenerative braking mode is activated and the accelerator pedal position.

14. The method of claim 13, wherein the determining of whether the wheel slip of the vehicle has occurred further includes:
estimating, by the controller, the wheel slip based on the vehicle velocity and the wheel speed;
concluding, by the controller, that the wheel slip has not occurred when the wheel slip is less than a reference slip; and
concluding, by the controller, that the wheel slip has occurred when the wheel slip is equal to or greater than the reference slip.

15. The method of claim 12, wherein the determining of the first regenerative braking amount includes:
estimating, by the controller, a weight center point height of the vehicle mapped to a vehicle weight with reference to a lookup table stored in advance; and
estimating, by the controller, a current deceleration of the vehicle using the vehicle velocity or the wheel speed.

16. The method of claim 15, wherein the determining of the first regenerative braking amount further includes:
determining, by the controller, a maximum regenerative braking force and a regenerative braking vehicle velocity range allowed by the drive motor; and
maximizing, by the controller, a regeneration amount by the drive motor by distributing a front axle braking force and a rear axle braking force based on the maximum regenerative braking force and a limit braking ratio between a front axle and a rear axle of the vehicle for each deceleration based on an ideal braking force diagram within the regenerative braking vehicle velocity range.

17. The method of claim 16, wherein the determining of the first regenerative braking amount further includes:
limiting, by the controller, a front axle regenerative braking limit value to a current front axle control amount when only a front-wheel slip occurs; and
limiting, by the controller, a rear axle regenerative braking limit value in accordance with the limit braking ratio based on the limited front axle regenerative braking limit value.

18. The method of claim 16, wherein the determining of the first regenerative braking amount further includes:
limiting, by the controller, a rear axle regenerative braking limit value to a current rear axle control amount when only a rear-wheel slip occurs; and
limiting, by the controller, a front axle regenerative braking limit value in accordance with the limit braking ratio based on the limited rear axle regenerative braking limit value.

19. The method of claim 16, wherein the determining of the first regenerative braking amount further includes:
limiting, by the controller, a front axle regenerative braking limit value and a rear axle regenerative braking limit value to current control amounts of the front axle and the rear axle, respectively, when a front-wheel slip and a rear-wheel slip occur; and
reducing, by the controller, an opponent axle regenerative braking limit value to a smaller value of an ideal braking force diagram-based regenerative braking limit value and a current regenerative braking limit value.

20. The method of claim 16, wherein the determining of the second regenerative braking amount includes:
determining, by the controller, an average of an optimal efficiency point region of an anti-lock brake system (ABS) as a target slip; and
increasing, decreasing, or maintaining, by the controller, a regenerative braking amount of an axle in accordance with a result of comparison between a slip of the corresponding axle and the target slip.
